(19) United States
(12) Patent Application Publication
(10) Pub. No.: US 2022/0032503 A1
(43) Pub. Date: Feb. 3, 2022

(54) Si SUBSTRATE MANUFACTURING METHOD

(71) Applicant: DISCO CORPORATION, Tokyo (JP)

(72) Inventors: Kazuya HIRATA, Tokyo (JP); Shin TABATA, Tokyo (JP)

(21) Appl. No.: 17/443,692

(22) Filed: Jul. 27, 2021

(30) Foreign Application Priority Data
Jul. 29, 2020 (JP) 2020-128469

(51) Int. Cl. B28D 5/00; B23K 26/53; B23K 26/067; B23K 26/082; B23K 26/0622

(52) U.S. Cl. CPC B28D 5/0011; B28D 5/0094; B23K 26/0622; B23K 26/067; B23K 26/082; B23K 26/53

(57) ABSTRACT

An Si substrate manufacturing method includes a separation band forming step of forming a separation band through positioning a focal point of a laser beam with a wavelength having transmissibility with respect to Si to a depth, equivalent to a thickness of an Si substrate to be manufactured, from a flat surface of an Si ingot and irradiating the Si ingot with the laser beam while relatively moving the focal point and the Si ingot in a direction <110> parallel to a cross line at which a crystal plane {100} and a crystal plane {111} intersect or a direction [110] orthogonal to the cross line, and an indexing feed step of executing indexing feed of the focal point and the Si ingot relatively in a direction orthogonal to a direction in which the separation band is formed.

### BACKGROUND OF THE INVENTION

### Field of the Invention

The present invention relates to an Si substrate manufacturing method for manufacturing an Si substrate from an Si ingot.

### Description of the Related Art

A wafer in which plural devices such as an integrated circuit (IC) and a large scale integration (LSI) circuit are formed on an upper surface of a silicon substrate in such a manner as to be marked out by plural planned dividing lines that intersect is divided into individual device chips by a dicing apparatus or a laser processing apparatus. The respective device chips obtained by the dividing are used for electrical equipment such as portable phones and personal computers.

A silicon (Si) substrate is formed through slicing of an Si ingot into a thickness of approximately 1 mm by a cutting apparatus including an inner diameter blade, a wire saw, or the like, lapping, and polishing (for example, refer to Japanese Patent Laid-open No. 2000-94221).

### SUMMARY OF THE INVENTION

However, the cutting allowance of the inner diameter blade and the wire saw is as comparatively large as approximately 1 mm. Therefore, when Si substrates are manufactured from an Si ingot by the inner diameter blade or the wire saw, there is a problem that the amount of material used as the Si substrates is approximately 1/3 of the Si ingot and the productivity is low.

Thus, an object of the present invention is to provide an Si substrate manufacturing method that enables an Si substrate to be efficiently manufactured from an Si ingot.

In accordance with an aspect of the present invention, there is provided an Si substrate manufacturing method for manufacturing an Si substrate from an Si ingot in which a crystal plane (100) is made to be a flat surface. The Si substrate manufacturing method includes a separation band forming step of forming a separation band through positioning a focal point of a laser beam with a wavelength having transmissibility with respect to Si to a depth equivalent to a thickness of the Si substrate to be manufactured from the flat surface and irradiating the Si ingot with the laser beam while relatively moving the focal point and the Si ingot in a direction <110> parallel to a cross line at which a crystal plane {100} and a crystal plane {111} intersect or a direction [110] orthogonal to the cross line; an indexing feed step of executing indexing feed of the focal point and the Si ingot relatively in a direction orthogonal to a direction in which the separation band is formed; and a wafer manufacturing step of repeatedly executing the separation band forming step and the indexing feed step to form a separation layer parallel to the crystal plane (100) as a whole inside the Si ingot and separating the Si substrate from the Si ingot at the separation layer to manufacture the Si substrate.

Preferably, the laser beam is caused to branch into a plurality of laser beams in a direction of the indexing feed to form respective focal points. It is preferable in the indexing feed step to execute the indexing feed in such a manner that the separation bands that are adjacent are in contact with each other. Preferably, the Si substrate manufacturing method further includes a planarization step of planarizing the crystal plane (100) of the Si ingot before the separation band forming step.

According to the present invention, it becomes possible to efficiently manufacture the Si substrates from the Si ingot.

The above and other objects, features and advantages of the present invention and the manner of realizing them will become more apparent, and the invention itself will best be understood from a study of the following description and appended claims with reference to the attached drawings showing a preferred embodiment of the invention.

### BRIEF DESCRIPTION OF THE DRAWINGS

FIG. 1A is a perspective view of an Si ingot;

FIG. 1B is a plan view of the Si ingot illustrated in FIG. 1A;

FIG. 2A is a perspective view of another Si ingot;

FIG. 2B is a plan view of the Si ingot illustrated in FIG. 2A;

FIG. 3 is a schematic diagram of a laser processing apparatus;

FIG. 4A is a perspective view illustrating a state in which a separation band forming step is being executed;

FIG. 4B is a front view illustrating the state in which the separation band forming step is being executed;

FIG. 5A is a sectional view of an Si ingot in which separation bands are formed;

FIG. 5B is an enlarged view of one of the separation bands in FIG. 5A;

FIG. 6 is a graph illustrating a relation between the number of branches of a laser beam and a length of a crack;

FIG. 7 is a graph illustrating a relation between an interval between focal points of branched laser beams and the length of the crack;

FIG. 8 is a graph illustrating a relation between a processing feed rate and the length of the crack;

FIG. 9 is a graph illustrating a relation between an output power of the laser beam and the length of the crack;

FIG. 10A is a perspective view illustrating a state in which the Si ingot is positioned under a separating apparatus;

FIG. 10B is a perspective view illustrating a state in which a separation step is being executed by using the separating apparatus;

FIG. 10C is a perspective view of the Si ingot and an Si substrate;

FIG. 11 is a schematic sectional view illustrating a state in which the separation step is being executed by applying ultrasonic waves to the Si ingot in which a separation layer is formed;

FIG. 12 is a perspective view illustrating a state in which a wafer grinding step is being executed; and

FIG. 13 is a perspective view illustrating a state in which a planarization step is being executed.

### DETAILED DESCRIPTION OF THE PREFERRED EMBODIMENT

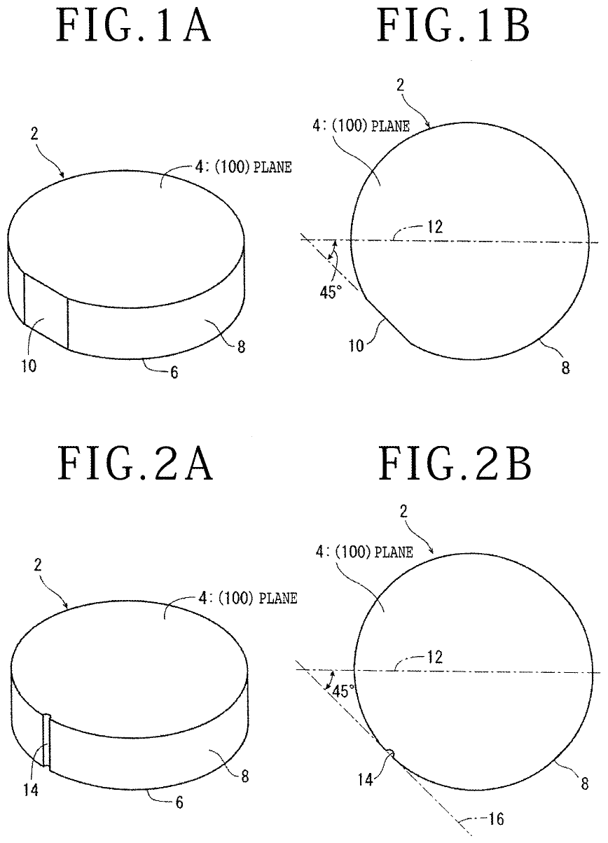

A preferred embodiment of the Si substrate manufacturing method of the present invention will be described below with reference to the drawings. In FIGS. 1A and 1B, a silicon (Si) ingot 2 with which the Si substrate manufacturing method of the present invention can be executed is illustrated. The Si ingot 2 is formed into a circular column shape as a whole and has a circular first end surface 4 obtained by making a crystal plane (100) be a flat surface, a circular second end surface 6 on an opposite side from the first end surface 4, and a circumferential surface 8 located between the first end surface 4 and the second end surface 6. A flat rectangular orientation flat 10 is formed in the circumferential surface 8 of the Si ingot 2. The orientation flat 10 is positioned in such a manner that an angle with respect to a cross line 12 at which the crystal plane {100} and a crystal plane {111} intersect is 45°.

As illustrated in FIGS. 2A and 2B, in the circumferential surface 8 of the Si ingot 2, a notch 14 that extends in an axis direction may be formed instead of the orientation flat 10. As is understood through reference to FIG. 2B, the notch 14 is positioned in such a manner that an angle formed between a tangent 16 at the notch 14 and the cross line 12 is 45°. In the following description, a method for manufacturing an Si substrate from the Si ingot 2 in which the orientation flat 10 is formed will be described.

In the present embodiment, first, a separation band forming step is executed in which a separation band is formed through positioning a focal point of a laser beam with a wavelength having transmissibility with respect to Si to a depth, equivalent to a thickness of an Si substrate to be manufactured, from the flat surface (first end surface 4) and irradiating the Si ingot 2 with the laser beam while relatively moving the focal point and the Si ingot 2 in a direction <110> parallel to the cross line 12 at which the crystal plane {100} and the crystal plane {111} intersect or a direction [110] orthogonal to the cross line 12.

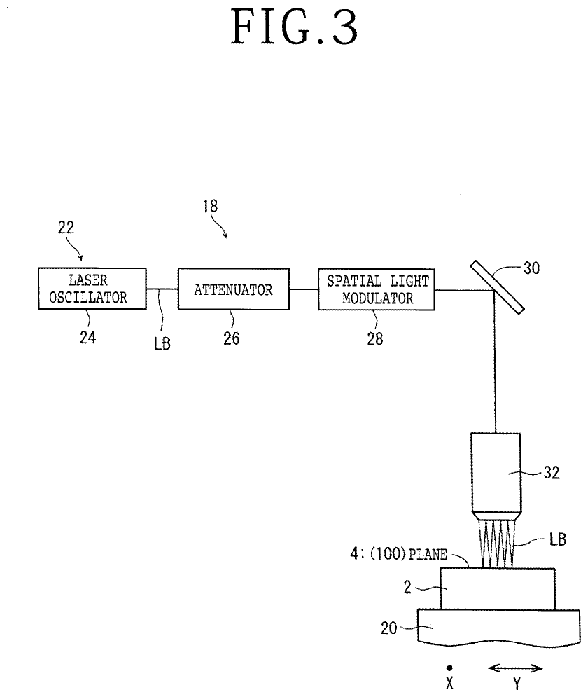

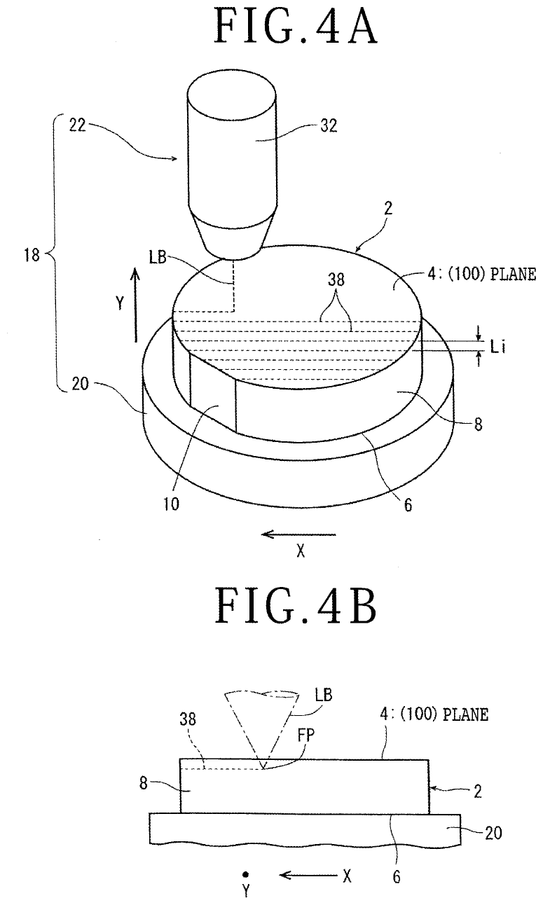

The separation band forming step can be executed by using a laser processing apparatus 18 partly illustrated in FIGS. 3 and 4A, for example. The laser processing apparatus 18 includes a holding table 20 that holds the Si ingot 2 and a laser beam irradiation unit 22 that irradiates the Si ingot 2 held by the holding table 20 with a pulsed laser beam LB.

The holding table 20 is configured rotatably around an axis line that extends in an upward-downward direction and is configured to be capable of advancing and retreating in each of an X-axis direction indicated by an arrow X in FIGS. 3, 4A, and 4B and a Y-axis direction (direction indicated by an arrow Y in FIGS. 3, 4A, and 4B) orthogonal to the X-axis direction. Further, the holding table 20 is configured movably from a processing region of the laser processing apparatus 18 to a processing region of each of a separating apparatus 42 and a grinding apparatus 62 to be described later. The plane defined by the X-axis direction and the Y-axis direction is substantially horizontal.

Referring to FIG. 3, the laser beam irradiation unit 22 includes a laser oscillator 24 that emits a pulsed laser beam LB with a wavelength having transmissibility with respect to Si, an attenuator 26 that adjusts an output power of the pulsed laser beam LB emitted from the laser oscillator 24, and a spatial light modulator 28 that causes the pulsed laser beam LB for which the output power has been adjusted by the attenuator 26 to branch into plural (for example, five) beams at predetermined intervals in the Y-axis direction. The laser beam irradiation unit 22 further includes a mirror 30 that reflects the pulsed laser beams LB branched by the spatial light modulator 28 and changes an optical path direction thereof and a laser condenser 32 that condenses the pulsed laser beam LB reflected by the mirror 30 and irradiates the Si ingot 2 with the pulsed laser beam LB.

In the separation band forming step, first, the Si ingot 2 is fixed to an upper surface of the holding table 20 with interposition of an appropriate adhesive (for example, epoxy resin-based adhesive). Alternatively, plural suction holes may be formed in the upper surface of the holding table 20 and the Si ingot 2 may be held under suction through generating a suction force for the upper surface of the holding table 20.

Subsequently, the Si ingot 2 is imaged from above by an imaging unit (not illustrated) of the laser processing apparatus 18, and the holding table 20 is rotated and moved based on an image of the Si ingot 2 imaged by the imaging unit. Thereby, an orientation of the Si ingot 2 is adjusted to a predetermined orientation, and positions of the Si ingot 2 and the laser condenser 32 in the XY-plane are adjusted. When the orientation of the Si ingot 2 is adjusted to the predetermined orientation, as illustrated in FIG. 4A, the adjustment is executed in such a manner that an angle formed between the X-axis direction and the orientation flat 10 becomes 45°, and the direction <110> parallel to the cross line 12 at which the crystal plane {100} and the crystal plane {111} intersect is aligned with the X-axis direction.

Subsequently, the laser condenser 32 is raised and lowered by focal point position adjusting means (not illustrated) of the laser processing apparatus 18, and a focal point FP (see FIG. 4B) of the pulsed laser beam LB is positioned to a depth, equivalent to the thickness of an Si substrate to be manufactured, from the first end surface 4 that is a flat surface. The pulsed laser beam LB of the present embodiment is caused to branch into plural beams at predetermined intervals in the Y-axis direction by the spatial light modulator 28, and the focal points FP of the branched pulsed laser beams LB are positioned to the same depth.

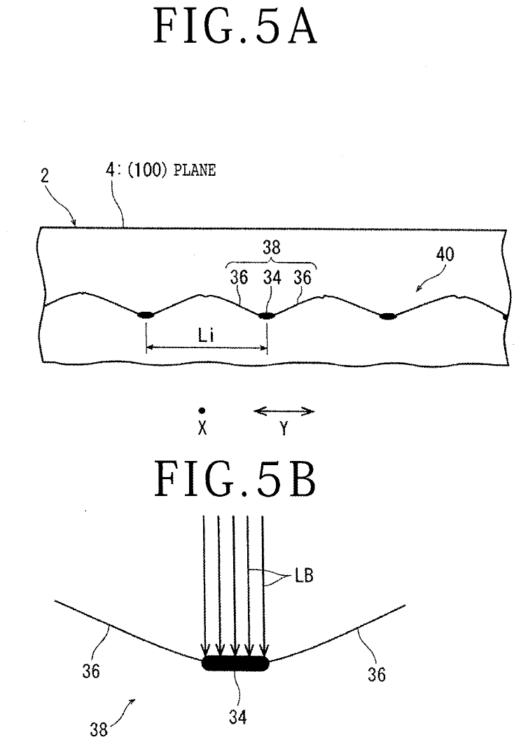

Subsequently, while the holding table 20 is moved at a predetermined feed rate in the X-axis direction aligned with the direction <110> parallel to the cross line 12 illustrated in FIGS. 1B and 2B at which the crystal plane {100} and the crystal plane {111} intersect, the Si ingot 2 is irradiated with the pulsed laser beam LB with a wavelength having transmissibility with respect to Si from the laser condenser 32. Thereupon, as illustrated in FIGS. 5A and 5B, a crystal structure is broken near five focal points FP of the pulsed laser beam LB, and a separation band 38 in which cracks 36 isotropically extend from a part 34 at which the crystal structure is broken along a (111) plane is formed along the <110> direction (X-axis direction). In the present embodiment, the focal point FP and the Si ingot 2 are relatively moved in the direction <110> parallel to the cross line 12 at which the crystal plane {100} and the crystal plane {111} intersect. However, the separation band 38 similar to the above-described one is formed also when the focal point FP and the Si ingot 2 are relatively moved in the direction [110] orthogonal to the cross line 12. In the separation band forming step, the laser condenser 32 may be moved in the X-axis direction instead of the holding table 20. Further, in the present embodiment, the Si ingot 2 is irradiated with plural beams branched from the pulsed laser beam LB. However, the Si ingot 2 may be irradiated with the pulsed laser beam LB without causing the pulsed laser beam LB to branch.

Subsequently, an indexing feed step of executing indexing feed of the focal point FP and the Si ingot 2 relatively in the direction orthogonal to the direction in which the separation band 38 is formed is executed. In the indexing feed step of the present embodiment, indexing feed of the holding table 20 is executed by a predetermined index amount Li (see FIG. 4A) in the Y-axis direction orthogonal to the <110> direction (X-axis direction) in which the separation band 38 is formed. In the indexing feed step, indexing feed of the laser condenser 32 instead of the holding table 20 may be executed.

Subsequently, a wafer manufacturing step is executed in which the separation band forming step and the indexing feed step are repeatedly executed to form a separation layer parallel to the crystal plane (100) as a whole inside the Si ingot 2, and an Si substrate is separated from the Si ingot 2 at the separation layer to manufacture the Si substrate.

By repeatedly executing the separation band forming step and the indexing feed step, as illustrated in FIG. 5A, a separation layer 40 that is composed of plural separation bands 38 and in which strength is lowered can be formed inside the Si ingot 2. The cracks 36 of each separation band 38 extend along the (111) plane. However, as is understood through reference to FIG. 5A, the separation layer 40 composed of the plural separation bands 38 is parallel to the first end surface 4 as a whole.

A slight gap may be set between the cracks 36 of adjacent separation bands 38. However, it is preferable to execute indexing feed in such a manner that the adjacent separation bands 38 are in contact with each other in the indexing feed step. This can cause the adjacent separation bands 38 to be coupled to each other and further reduce the strength of the separation layer 40. Thus, separation of an Si substrate from the Si ingot 2 becomes easy in a separation step to be described later.

It is desirable to employ the following processing conditions as processing conditions adopted to form such a separation layer 40. The present inventor and so forth have made experiments under various conditions. As a result, they have found that, when the separation band 38 is formed under the following processing conditions, the cracks 36 of the separation band 38 become longer, and therefore, the index amount Li can be made longer, so that the time taken to form the separation layer 40 can be shortened.

Wavelength of laser beam: 1342 nm

Average output power of laser beam before branching: 2.5 W

Number of branches of laser beam: 5 (based on the result of experiment 1 to be described below)

Interval between focal points of branched laser beams: 10 μm (based on the result of experiment 2 to be described below)

Repetition frequency: 60 kHz

Feed rate: 300 mm/s (based on the result of experiment 3 to be described below)

Index amount: 320 μm (based on the result of experiment 4 to be described below)

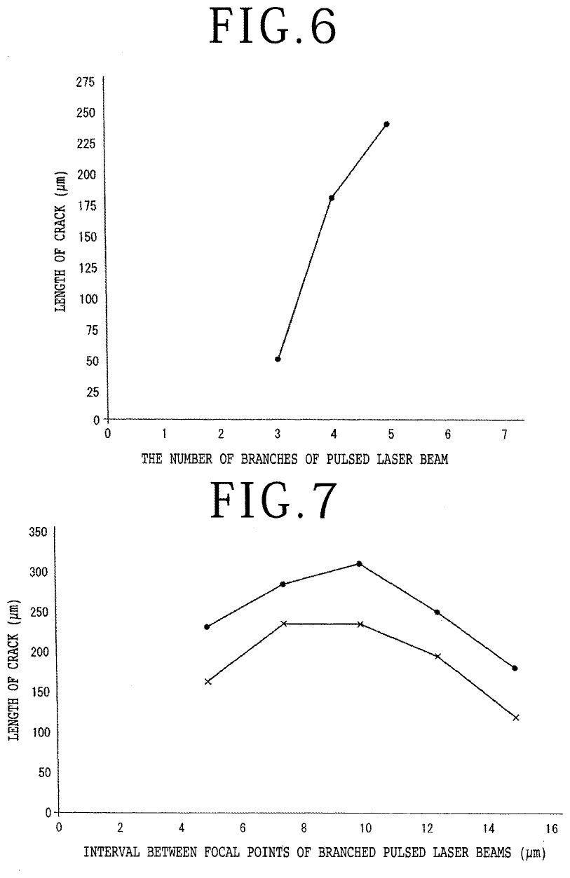

With reference to FIGS. 6 to 9, results of experiments that have been made by the present inventor and so forth and relate to formation of the separation layer will be described. While changing each of the number of branches of the pulsed laser beam, the interval between the focal points of the branched laser beams, the relative feed rate of the Si ingot and the focal points, and the output power of the pulsed laser beam, the present inventor and so forth measured the length of the crack of the separation band when the focal points of the pulsed laser beam with a wavelength having transmissibility with respect to Si were positioned to a depth, equivalent to the thickness of an Si substrate to be manufactured, from the upper end surface (upper end surface obtained by making the crystal plane (100) be a flat surface) and the Si ingot was irradiated with the pulsed laser beam while the focal points and the Si ingot were relatively moved in the direction <110> parallel to the cross line at which the crystal plane {100} and the crystal plane {111} intersected. The processing conditions other than parameters changed in each experiment to be described below were set in the same manner as the above-described processing conditions, and description about the processing conditions other than the changed parameters is omitted.

### <Experiment 1>

FIG. 6 illustrates the measurement result of the length of the crack of the separation band in the Y-axis direction when the average output power per one beam after branching was set to 0.5 W and the number of branches of the pulsed laser beam was changed. As illustrated in FIG. 6, in the cases in which the number of branches was 3, 4, and 5, the length of the crack became longer when the number of branches of the pulsed laser beam was larger.

### <Experiment 2>

FIG. 7 illustrates the measurement result of the length of the crack of the separation band in the Y-axis direction when the interval between the focal points of the branched pulsed laser beams was changed (black circle marks). As illustrated in FIG. 7, the length of the crack was the maximum when the interval between the focal points of the branched pulsed laser beams was 10 μm. Further, FIG. 7 also illustrates, as a comparative example, a result when the Si ingot was irradiated with the pulsed laser beam while the focal points and the Si ingot were relatively moved in the direction parallel to the orientation flat (cross marks). As is understood through reference to FIG. 7, irrespective of the interval between the focal points of the branched pulsed laser beams, the length of the crack became longer when the focal points and the Si ingot were relatively moved in the direction <110> parallel to the cross line at which the crystal plane {100} and the crystal plane {111} intersected (black circle marks) than when the focal points and the Si ingot were relatively moved in parallel to the orientation flat (cross marks).

### <Experiment 3>

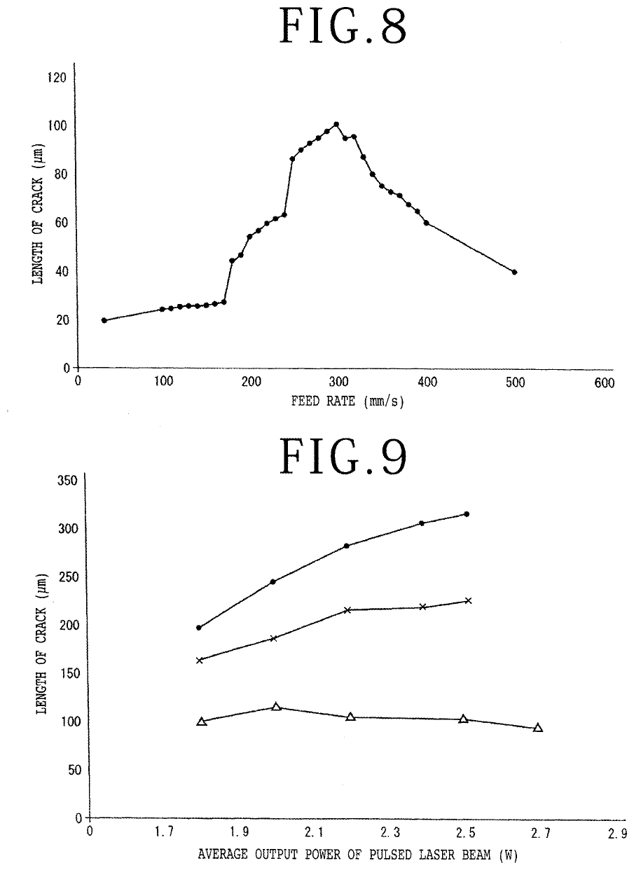

FIG. 8 illustrates the measurement result of the length of the crack of the separation band in the Y-axis direction when the relative feed rate of the Si ingot and the focal points was changed. As is understood through reference to FIG. 8, the length of the crack was the maximum when the feed rate was set to 300 mm/s. In experiment 3, checking the optimum feed rate was the object. Thus, the processing was executed with the number of branches of the pulsed laser beam set to 3, and with the average output power of the pulsed laser beam set to 1.8 W (average output power 0.5 W per one beam after branching).

### <Experiment 4>

FIG. 9 illustrates the measurement result of the length of the crack of the separation band in the Y-axis direction when the average output power of the pulsed laser beam before branching was changed. In FIG. 9, a line graph indicated with black circle marks corresponds to the case in which the number of branches was 5 and the focal points and the Si ingot were relatively moved in the direction <110> parallel to the cross line at which the crystal plane {100} and the crystal plane {111} intersected. A line graph indicated with cross marks corresponds to the case in which the number of branches was 5 and the focal points and the Si ingot were relatively moved in parallel to the orientation flat. A line graph indicated with triangle marks corresponds to the case in which the number of branches was 3 and the focal points and the Si ingot were relatively moved in the direction <110> parallel to the cross line at which the crystal plane {100} and the crystal plane {111} intersected.

From FIG. 9, the following facts were revealed: (1) the crack became longer when the output power of the pulsed laser beam was higher, (2) the crack became longer when the number of branches was larger, and (3) the crack became longer when the focal points and the Si ingot were relatively moved in the direction <110> parallel to the cross line at which the crystal plane {100} and the crystal plane {111} intersected than when the focal points and the Si ingot were relatively moved in parallel to the orientation flat. Further, as is understood through reference to FIG. 9, the length of the crack was the maximum (320 μm) when the output power was 2.5 W in the line graph indicated with the black circle marks.

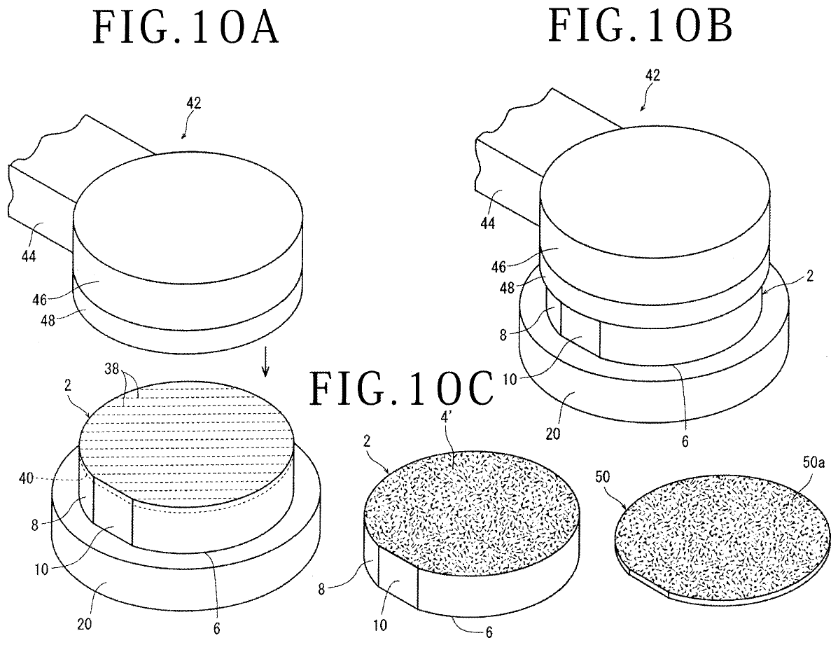

To return to the explanation about the wafer manufacturing step, after the separation layer 40 is formed inside the Si ingot 2, an Si substrate is separated from the Si ingot 2 at the separation layer 40 to manufacture the Si substrate. The separation of the Si substrate from the Si ingot 2 at the separation layer 40 can be executed by using the separating apparatus 42 illustrated in FIGS. 10A and 10B, for example.

As illustrated in FIGS. 10A and 10B, the separating apparatus 42 includes an arm 44 that extends in a substantially horizontal direction and a motor 46 attached to a tip of the arm 44. A suction adhesion piece 48 with a circular plate shape is coupled to a lower surface of the motor 46 rotatably around an axis line that extends in the upward-downward direction. In the suction adhesion piece 48 configured to cause suction adhesion of a workpiece at a lower surface thereof, ultrasonic vibration applying means (not illustrated) that applies ultrasonic vibrations to the lower surface of the suction adhesion piece 48 is incorporated.

The explanation will be continued with reference to FIGS. 10A to 10C. After the separation layer 40 is formed inside the Si ingot 2, the holding table 20 that holds the Si ingot 2 is moved to a lower side of the suction adhesion piece 48. Subsequently, the arm 44 is lowered, and suction adhesion of the lower surface of the suction adhesion piece 48 to the first end surface 4 (end surface closer to the separation layer 40) of the Si ingot 2 is caused as illustrated in FIG. 10B. Subsequently, the ultrasonic vibration applying means is actuated to apply ultrasonic vibrations to the lower surface of the suction adhesion piece 48. In addition, the suction adhesion piece 48 is rotated by the motor 46. Thereby, as illustrated in FIG. 10C, an Si substrate 50 (wafer) can be separated from the Si ingot 2 with the separation layer 40 being a point of origin, to thereby manufacture the Si substrate 50.

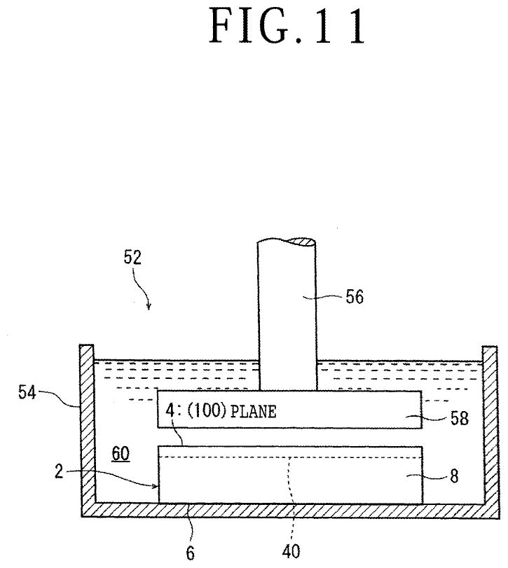

Further, when the Si substrate 50 is to be separated from the Si ingot 2 at the separation layer 40, a separating apparatus 52 illustrated in FIG. 11 may be used. The separating apparatus 52 illustrated in FIG. 11 includes a water tank 54, a rod 56 disposed in the water tank 54 in such a manner as to be capable of rising and lowering, and an ultrasonic oscillating component 58 mounted on a lower end of the rod 56.

When the Si substrate 50 is to be separated from the Si ingot 2 by using the separating apparatus 52, the Si ingot 2 is immersed in water 60 in the water tank 54. Subsequently, the rod 56 is moved to position the ultrasonic oscillating component 58 to a position slightly above the first end surface 4 of the Si ingot 2. It suffices that an interval between the first end surface 4 of the Si ingot 2 and the ultrasonic oscillating component 58 is approximately 1 mm. Then, by oscillating ultrasonic waves from the ultrasonic oscillating component 58 and stimulating the separation layer 40 through a layer of the water 60, the Si substrate 50 can be separated from the Si ingot 2 with the separation layer 40 being the point of origin.

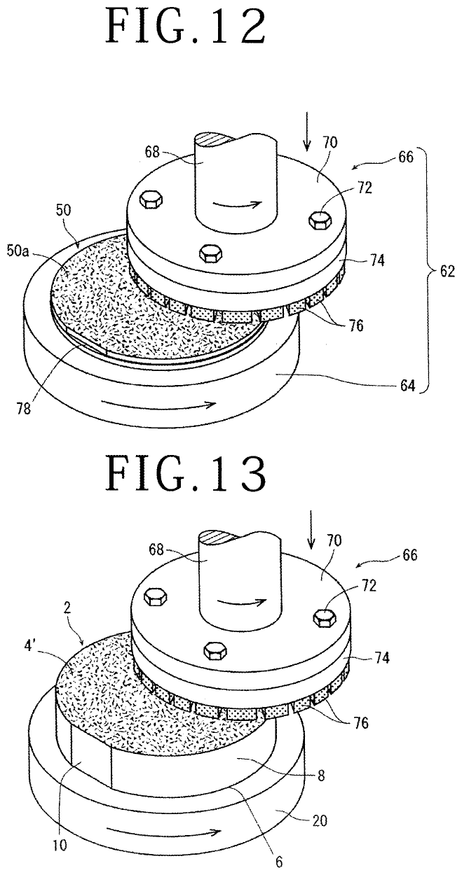

After the wafer manufacturing step is executed, a wafer grinding step of grinding a separation surface 50a of the Si substrate 50 to planarize the separation surface 50a is executed. The wafer grinding step can be executed by using the grinding apparatus 62 partially illustrated in FIG. 12, for example. The grinding apparatus 62 includes a chuck table 64 that holds the Si substrate 50 under suction and grinding means 66 that grinds the Si substrate 50 held by the chuck table 64. The chuck table 64 that holds the Si substrate 50 under suction at an upper surface thereof is configured rotatably around an axis line that extends in the upward-downward direction.

As illustrated in FIG. 12, the grinding means 66 includes a spindle 68 configured to be capable of rotating with the upward-downward direction being an axial center and a wheel mount 70 that is fixed to a lower end of the spindle 68 and that has a circular plate shape. An annular grinding wheel 74 is fixed to a lower surface of the wheel mount 70 by bolts 72. To an outer circumferential edge part of a lower surface of the grinding wheel 74, plural grinding abrasive stones 76 annularly disposed at intervals in a circumferential direction are fixed.

The explanation will be continued with reference to FIG. 12. In the wafer grinding step, first, a substrate 78 with a circular plate shape is mounted on a surface of the Si substrate 50 on an opposite side from the separation surface 50a by using an appropriate adhesive. Subsequently, the Si substrate 50 is held under suction together with the substrate 78 by the upper surface of the chuck table 64 with the separation surface 50a of the Si substrate 50 oriented upward. Subsequently, the chuck table 64 is rotated at a predetermined rotation speed (for example, 300 rpm) in an anticlockwise direction as viewed from above. Further, the spindle 68 is rotated at a predetermined rotation speed (for example, 6000 rpm) in the anticlockwise direction as viewed from above. Subsequently, the spindle 68 is lowered by raising-lowering means (not illustrated) of the grinding apparatus 62, and the grinding abrasive stones 76 are brought into contact with the separation surface 50a of the Si substrate 50. Then, after the grinding abrasive stones 76 are brought into contact with the separation surface 50a of the Si substrate 50, the spindle 68 is lowered at a predetermined grinding feed rate (for example, 1.0 μm/s). Thereby, the separation surface 50a of the Si substrate 50 can be ground, and the Si substrate 50 can be planarized. After the separation surface 50a is ground, the planarized separation surface 50a may be polished until desired surface roughness is obtained, by using an appropriate polishing apparatus.

Further, after the wafer manufacturing step is executed, before or after the wafer grinding step or concurrently with the wafer grinding step, a planarization step of grinding a separation surface 4′ of the Si ingot 2 from which the Si substrate 50 has been separated to planarize the crystal plane (100) is executed.

In the case of executing the planarization step before or after the wafer grinding step, the planarization step can be executed by using the grinding means 66 of the above-described grinding apparatus 62. In the case of executing the planarization step by using the grinding means 66, first, the chuck table 64 is separated from the position below the grinding means 66, and thereafter, the holding table 20 that holds the Si ingot 2 is moved to the position below the grinding means 66 as illustrated in FIG. 13.

Subsequently, similarly to when the separation surface 50a of the Si substrate 50 is ground, the holding table 20 is rotated in the anticlockwise direction as viewed from above, and the spindle 68 is rotated in the anticlockwise direction as viewed from above. Then, the spindle 68 is lowered, and the grinding abrasive stones 76 are brought into contact with the separation surface 4′ of the Si ingot 2. Thereafter, the spindle 68 is lowered at a predetermined grinding feed rate. Thereby, the separation surface 4′ of the Si ingot 2 can be ground, and the crystal plane (100) of the Si ingot 2 can be planarized. The planarization step may be executed concurrently with the wafer grinding step, by using another grinding apparatus having grinding means similar to that of the grinding apparatus 62. Further, after the separation surface 4′ is ground, the planarized crystal plane (100) may be polished until desired surface roughness is obtained, by using an appropriate polishing apparatus.

Then, after the planarization step is executed, the above-described separation band forming step, indexing feed step, wafer manufacturing step, wafer grinding step, and planarization step are repeated to manufacture plural Si substrates 50 from the Si ingot 2. In the present embodiment, the example in which the Si substrate manufacturing method is started from the separation band forming step is described because the first end surface 4 of the Si ingot 2 is a surface obtained by making the crystal plane (100) be a flat surface. However, the Si substrate manufacturing method may be started from the planarization step when the first end surface 4 of the Si ingot 2 is not a surface obtained by making the crystal plane (100) be a flat surface.

As described above, in the Si substrate manufacturing method of the present embodiment, the Si ingot 2 is irradiated with the pulsed laser beam LB to form the separation layer 40, and the Si substrate 50 is separated from the Si ingot 2 with the separation layer 40 being the point of origin. Therefore, there is no cutting allowance, and it becomes possible to efficiently manufacture the Si substrates 50 from the Si ingot 2.

The present invention is not limited to the details of the above described preferred embodiment. The scope of the invention is defined by the appended claims and all changes and modifications as fall within the equivalence of the scope of the claims are therefore to be embraced by the invention.

What is claimed is:

1. A silicon substrate manufacturing method for manufacturing a silicon substrate from a silicon ingot in which a crystal plane (100) is made to be a flat surface, the silicon substrate manufacturing method comprising:
a separation band forming step of forming a separation band through positioning a focal point of a laser beam with a wavelength having transmissibility with respect to silicon to a depth equivalent to a thickness of the silicon substrate to be manufactured from the flat surface and irradiating the silicon ingot with the laser beam while relatively moving the focal point and the silicon ingot in a direction <110> parallel to a cross line at which a crystal plane {100} and a crystal plane {111} intersect or a direction [110] orthogonal to the cross line;
an indexing feed step of executing indexing feed of the focal point and the silicon ingot relatively in a direction orthogonal to a direction in which the separation band is formed; and
a wafer manufacturing step of repeatedly executing the separation band forming step and the indexing feed step to form a separation layer parallel to the crystal plane (100) as a whole inside the silicon ingot and separating the silicon substrate from the silicon ingot at the separation layer to manufacture the silicon substrate.

2. The silicon substrate manufacturing method according to claim 1, wherein
the laser beam is caused to branch into a plurality of laser beams in a direction of the indexing feed to form respective focal points.

3. The silicon substrate manufacturing method according to claim 1, wherein,
in the indexing feed step, the indexing feed is executed in such a manner that the separation bands that are adjacent are in contact with each other.

4. The silicon substrate manufacturing method according to claim 1, further comprising:
a planarization step of planarizing the crystal plane (100) of the silicon ingot before the separation band forming step.
